(19) United States
(12) Patent Application Publication
(10) Pub. No.: US 2014/0379398 A1
(43) Pub. Date: Dec. 25, 2014

(54) SHARED DIGITAL CONTENT BASED PROBLEM RESOLUTION SYSTEM AND METHOD

(71) Applicant: RAJESH AGRAWAL, Middlesex (GB)

(72) Inventor: RAJESH AGRAWAL, Middlesex (GB)

(21) Appl. No.: 14/308,728

(22) Filed: Jun. 19, 2014

(30) Foreign Application Priority Data
Jun. 20, 2013 (GB) 1310991.3
Jun. 17, 2014 (GB) 1410766.8

(51) Int. Cl. G06Q 10/06

(52) U.S. Cl. CPC G06Q 10/063112
USPC 705/7.14

(57) ABSTRACT

The present invention discloses a system and method for addressing and resolving a problem faced by a user, which is conveyed by means of a combination of digital media content including video, still images, audio, or text. The user can post a problem, such as a troubleshooting issue related to a physical device, such as an electronic good, or any tangible item related fault, for quick, prompt, efficient and economical resolution by the authorized company personnel or a professional expert, using a device such as an internet enabled hand held computing device, a tablet, a mobile telephone device or a smart phone.

### BACKGROUND

1. Technical Field of Invention

The present invention generally relates to a system and method for addressing and resolving a problem faced by a user, which is conveyed by means of a combination of digital media content including live video, recorded video, still images, audio, or text. More particularly the invention relates to a method wherein a user can post a problem, such as a troubleshooting issue related to a physical device, such as an electronic good, or any tangible item that has developed a fault that needs expert advise, consultation, attention, servicing, repair or correction. The problem is quickly, promptly, efficiently and economically resolved by the authorized company personnel or a professional expert on a paid basis, using an internet enabled computing device such as a hand held computing device, a tablet, a mobile telephone device, a smart phone.

2. Prior Art

Various methods are currently in practice for addressing or troubleshooting a problem faced by a user of a good. Most frequently used method is to contact the original manufacturing company who produced the good or the authorized dealer who sold the good to the user through communication means such as a telephone call, an email or a personal visit. Registering any issue reported by the user through either of these methods require that the problem be explained in detail. This can be particularly important when the problem is of a nature that cannot be explained in detail verbally by the user without referring to the particular good; for example, a washing machine is not draining water on completion of a wash cycle and producing a strange noise instead, or a microwave oven is not heating food even though power turns on. Sometimes an actual demonstration of the problem is more effective. In many a case, in spite of the user providing a detailed explanation of the problem, the customer care executive registers a complaint and arranges for the visit of a technician or servicing personnel to physically visit the customer site and assess the problem. This calls for unnecessary expenditure of time, effort and money for not only the user, but also the manufacturing or servicing company since they are required to track and service all customer complaints, majority of which are recurrent in nature, which can be resolved with a minor suggestion or input from the technician or servicing personnel.

Sometimes, users post the problems faced by them in online forums, where many people offer advice, solutions and suggestions to the posted problems. However there is no way by which a user can know how authentic and reliable these solutions are, since these responses do not have any liability. Therefore the user is hesitant about engaging the services of an expert without knowing his quality of work and may not be willing to pay for his services. Further many knowledgeable people who may be aware of the right solution based on prior experience or skill may not post their solutions since there is no motivation or incentive to encourage them to respond. On the other hand while the user is prepared to pay for this service, he ends up not only incurring higher expenses due to his ignorance, but also spends lot of time searching for the right skilled person to solve the problem.

Therefore, there is a need for a method and system that allows a user to share digital content pertaining to a problem related to a particular good such that it can be solved in an economical and quick manner by the company manufacturing or servicing the good or a skilled and experienced expert with or without physically visiting the actual site location of the good.

### SUMMARY OF THE INVENTION

In accordance with the teachings of the present invention, a system and a method for facilitating resolution of a user complaint pertaining to a good or tangible product by a company or an individual expert is provided wherein the problem as well as the solution are shared using either singly or a combination of digital media content including live video streaming in real time, recorded video, still images, audio, or text delivered through an internet enabled computing device, such as a mobile telephone device, a hand held computer, a tablet, a laptop computer or a smart phone, all of which are internet-enabled.

An object of the present invention is to provide a system and method for user problem resolution and management that allows a user to accurately depict the experienced problem in a digital content format that does not require him to repeat describing the same problem to multiple servicing people or customer care executives.

Another object of the present invention is to provide a system and method that allows the manufacturing or servicing company of the given good to gather, save and analyze all user complaints pertaining to use of a given good for the purpose of further product development and research and development strategies.

Another object of the present invention is to provide a system and method that provides the manufacturing or servicing company of the given good to collect and store product reviews from a user based on his experience while using the good, even when there is no problem associated with it.

A further object of the present invention is to provide a system and method that allows the manufacturing or servicing company of the given good to obtain accurate, real time user feedback and response regarding the resolution of a complaint or problem. Selected user feedback may also be used for advertizing and marketing purposes.

Yet another object of the present invention is to provide a system and method that allows the technician or servicing personnel of the manufacturing company to resolve common problems faced by several users by sharing digital content related to the solution, without actually visiting the user's premises.

A further object of the present invention is to provide a system and method that allows experienced and skilled individuals to use their knowledge to provide solutions to problems comprising of digital format that are shared by users on a paid basis.

Another object of the present invention is to assure a user that he is selecting a qualified professional based on a preview or partial view of a solution in return for a part payment.

Another object of the present invention is to provide a system wherein more than two parties, i.e. apart from the user and the servicing personnel of the company or the professional expert, are involved in providing a solution by way of communication in real time through means such as for example, live voice & video chat, telephonic discussion or an email exchange.

The present invention achieves the foregoing objects by providing a system for resolution and management of a user problem from a smart device through a website hosted on the internet comprising of:

a server having a CPU, the server capable of communicating with the smart device and receiving communication from the smart device, a module on the server capable of:

detecting a user's good associated with a problem,

identifying the manufacturing or servicing company of the good,

capturing in digital content format the problem associated with the good,

uploading the digital content format of the problem associated with the good to a web server,

receiving user preference regarding getting a solution to the complaint from the company servicing personnel or individual expert,

notifying pre-selected consultants from a company or individual experts regarding the uploaded problem,

allowing pre-selected consultants to access the uploaded problem,

receiving responses, including solutions, from pre-selected consultants regarding the uploaded problem in digital content format,

uploading on the web server responses in digital content format received from pre-selected consultants,

notifying the user regarding responses,

allowing the user to access uploaded responses based on pre-specified business logic and payment rules,

receiving and storing user feedback regarding the effectiveness of uploaded response in resolving the problem, and

receiving and storing user product review regarding the good.

These advantages in addition to other objects and advantages of the invention will be set forth in the description which follows, and in part will be obvious from the description, or may be learned by the practice of the invention. The objects and advantages of the invention may be realized and obtained by means of the software, algorithms, devices, remote servers and combinations thereof.

The foregoing discussion summarizes some of the more pertinent objects of the present invention. These objects should be construed to be merely illustrative of some of the more prominent features and applications of the invention. Accordingly, referring to the drawings may have a complete understanding of the invention.

### BRIEF DESCRIPTION OF THE DRAWINGS

For a more complete explanation of the present invention and the technical advantages thereof, reference is now made to the following description and the accompanying drawing in which:

FIG. 1 is an illustrative flow chart depicting the sequence of steps in the present invention.

FIG. 2 depicts the various operating modules with given functionality that would be implemented by the software application in the system.

FIG. 3 is a plan view of the messages displayed on a user's Smart Device.

FIG. 4 is a plan view of the messages displayed on an expert's Smart Device.

### DETAILED DESCRIPTION OF THE INVENTION

It is advantageous to define several terms, phrases and acronyms before describing the invention. It should be appreciated that the following terms are used throughout this application. Where the definition of terms departs from the commonly used meaning of the term, applicant intends to utilize the definitions provided below, unless specifically indicated. In some cases, more than two terms have been provided with a common definition wherein it is to be construed that both terms have the same meaning and have been used interchangeably and synonymously. For the purpose of describing the instant invention following definitions of the technical terms are stipulated:

1. Good: A physical product or a tangible component owned, purchased or being used by a user, for example, a washing machine, a microwave oven, a gas pipeline, a water pipeline.

2. Digital content: A digital media file comprising of one or more of audio, live streaming video, recorded video, images, computer generated graphics, or text.

3. Problem/complaint: A faulty issue associated with the use of good which is not letting it function as expected by the user.

4. User/customer: Person who uses or has purchased or owns the good.

5. Company: The entity that has manufactured the good or is its authorized representative for sales or servicing.

6. Company service/servicing professional: Employees of company.

7. Expert/Consultant/Technician: An individual not associated with Company, who works independently and has prior skills, experience or knowledge related to the good.

8. Solution/response: A solution to resolve the problem.

9. Smart device: An internet enabled computing device such as a hand held computer, a laptop, a mobile phone or a smart phone. “Smart device” as used in this patent application is broadly used to encompass any of a number of types of wireless portable personal communications devices that are carried by a user, including cellular phones, so-called “smart phones” that provide some type of mobile operating system, feature phones having at least some measure of computing capability, and various types of wireless, networked electronic pads, tablets, and similar devices that include at least a display area capable of displaying text and graphic content and a mechanism for entering data, such as phone numbers, message text, and prompt responses, for example. The mechanism for data entry typically includes a touch screen and may also include a keypad. Examples of smart devices that can be particularly useful for embodiments of the present invention include smartphones such as the Android™ smart phone platform (Android is a trademark of Google, Inc.), the iPhone (from Apple Inc.), and devices with similar capability for downloading and executing one or more sets of programmed instructions, such as software applications that are widely referred to as “apps” that display on the device.

10. App: Software application installed on smart device. In the context of the present invention, the term “app” is considered to be synonymous with the phrase “software application” or “software application program” and relates to a set of programmed instructions that execute on a computer or other logic processor, such as the logic processor that controls operation of a smartphone or other customer communications device. The customer communications device has a particular wireless address, typically a phone number, but optionally some other type of wireless address.

The present invention achieves the foregoing objects by providing a system for a user's problem resolution and management from a smart device through a website hosted on the internet comprising of:
a server having a CPU, the server capable of communicating with the smart device and receiving communication from the smart device, a module on the server capable of:
detecting a user's good associated with a problem,
identifying the manufacturing or servicing company of the good,
capturing in digital content format the problem associated with the good,
uploading the digital content format of the problem associated with the good to a web server,
receiving user preference regarding getting a solution to the complaint from the company servicing personnel or individual expert,
notifying pre-selected consultants from a company or individual experts regarding the uploaded problem,
allowing pre-selected consultants to access the uploaded problem,
receiving responses, including solutions, from pre-selected consultants regarding the uploaded problem in digital content format,
uploading on the web server responses in digital content format received from pre-selected consultants,
notifying the user regarding responses,
allowing the user to access uploaded responses based on pre-specified business logic and payment rules,
receiving and storing user feedback regarding the effectiveness of uploaded response in resolving the problem, and
receiving and storing user product review regarding the good.

The present system and method provides users with a software based application that can be installed on internet enabled smart device such as smart phones or other computing devices. This software can be used to send digital content including live video, recorded video, audio, pictures and/or text denoting the problem. This digital content pertaining to the problem is sent via the internet enabled smart device to a server from where it can be displayed on a web site, with access restricted to a pre-selected group of consultants comprising of company representatives or individual experts. However, in an alternate embodiment, the digital content information pertaining to the problem may be publically displayed on the website. The web site may be accessed from an internet enabled smart device such as a mobile device, personal computer, ipad or other tablet, laptop or from an internet-television, etc. The pre-selected group of consultants comprise of representatives of the manufacturing or servicing company employees or individual experts. They will receive email, text or audio alert notification that they should access the web site because a problem related to a good they manufacture or pertaining to their specialized skills has been uploaded. Company employees may automatically receive the complaint video of a good if it follows predetermined criteria such as within guarantee period, and they can simply click on their app to view the video, without having to otherwise access the website. When the app is installed on the smart device, the customer may also send live video stream or recorded video and other information wirelessly to a remote server. When the app is installed on a personal computer, laptop or internet television, etc., the customer can send video and other information via the internet to the server. A user can also establish a real time streaming video channel for a detailed explanation of the problem. This may not be required in all cases, but can be specified based on inputs from the preselected group of consultants comprising of company employees or expert user.

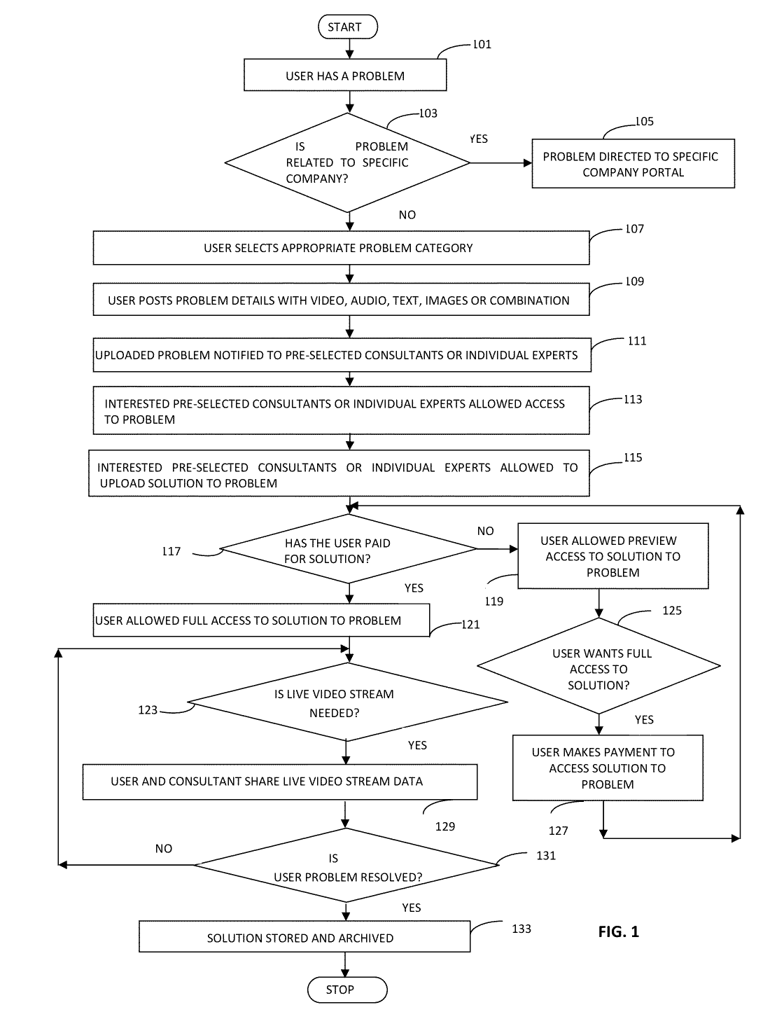

Referring to FIG. 1, an illustrative flow chart representing an embodiment of the invention is depicted. Step 101 denotes a user having a problem. The user may like the problem to be resolved by the company or an expert. Depending on the user's preference two processing methods are stipulated as per step 103 displayed in the flow chart. If the problem relates to a product or service from a specific company, then at step 105, the user is directed to the specific company portal. If the problem is generic in nature, then at step 107, the user selects the appropriate problem category. At step 109, the user uploads the problem in the form of digital content to a website using an app on an internet enabled smart device or by separately capturing it using a recording means such as a camera and uploading it on said website. Preselected consultants comprising of company employees or individual experts are notified about the uploaded problem and its associated digital content at step 111. These preselected consultants may review the uploaded problem and request for additional content through live video stream. At step 113, interested, preselected consultants are allowed access to the problem and its associated digital content. At step 115, interested, preselected consultants are allowed to upload solution to the uploaded problem. Over time, a repository of solutions is created and stored in a server. At step 117, it is determined whether the user has paid to obtain the solution. If the user has not paid for the solution then at step 119, the user is allowed a partial access or a preview to the solution wherein the complete solution is not made available to the user. At step 125, it is determined whether the user who has gained preview access is interested in accessing the complete solution on payment basis. If yes, then at step 127, the user makes full payment. The user is then allowed to access the complete solution to the problem at step 121. Subsequently it is determined at step 123, if a live video stream is needed as part of the solution. If yes, then at step 129, the user and the consultant share live video stream data, until it is determined at step 131 that the problem has been completely resolved. The solution is then stored and archived in a repository at step 133. The present invention also discloses a computer-implemented method comprising of:
(a) detecting a user's good associated with a problem,
(b) identifying the manufacturing or servicing company of the good,
(c) capturing in digital content format the problem associated with the good,
(d) uploading the digital content format of the problem associated with the good to a web server,
(e) receiving user preference regarding getting a solution to the complaint from the company servicing personnel or individual expert,
(f) notifying pre-selected consultants from a company or individual experts regarding the uploaded problem,
(g) allowing pre-selected consultants to access the uploaded problem,
(h) receiving responses, including solutions, from pre-selected consultants regarding the uploaded problem in digital content format,
(i) uploading on the web server responses in digital content format received from pre-selected consultants,
(j) notifying the user regarding responses,
(k) allowing the user to access uploaded responses based on pre-specified business logic and payment rules,
(l) receiving and storing user feedback regarding the effectiveness of uploaded response in resolving the problem, and
(m) receiving and storing user product review regarding the good.

Various embodiments of the invention are provided by the present invention by incorporating variations of business rules described herein. In case a solution to a problem uploaded by a user already exists in the database, the user is shown a partial preview of the solution, based on which the user may decide whether to make full payment in order to access the complete solution. On full payment, the user is shown the complete the solution. Depending on the complexity level of the problem, the user can also engage with a consultant in real time over a secure connection and share live video stream data till a complete resolution of the problem occurs. Various combinations of payment terms are available for the ease of the user. When the problem is successfully resolved, the solution which may have been delivered in the form of a digital content file is stored in a repository such as a database, for future use.

The company or expert may also opt to receive and record user feedback immediately. This feedback can be used for marketing and advertising purposes as well as for product development and research strategies. In an alternate embodiment, product review may be gathered from the user and stored for further analysis and development strategy, in a scenario when there is no problem reported by the user.

In an embodiment of the present invention, the concerned company pertaining to the good can be identified by ways such as pointing the smart device at the good. The unique identification number of the good and the company details may be found by scanning a customer identification number, a receipt number, an invoice number, a product identification number, a bar code or QR code provided on the good or its corresponding literature such as invoice or bills.

In an embodiment of the present invention, the problems reported by a user may be tagged by the user or the company professional using preselected categories and classification for the good and nature of problem, and then stored in a database. This would facilitate ease in searching and querying of the problems.

In yet another embodiment, the user and consultant can interact over a secured connection in real time to discuss the problem posted by the user and the solution offered by the consultant by live video streams. For example, a user facing problems in running a washing machine can engage with a consultant at a remote location by sharing the qualitative aspects of the problem by way of live video of the washing machine operating in a problematic manner such as running with an accompanying noise. Sharing of the problem and the solution in the form of digital content eliminates the barriers of language or comprehension of text in a user manual, making it simple for the user to understand.

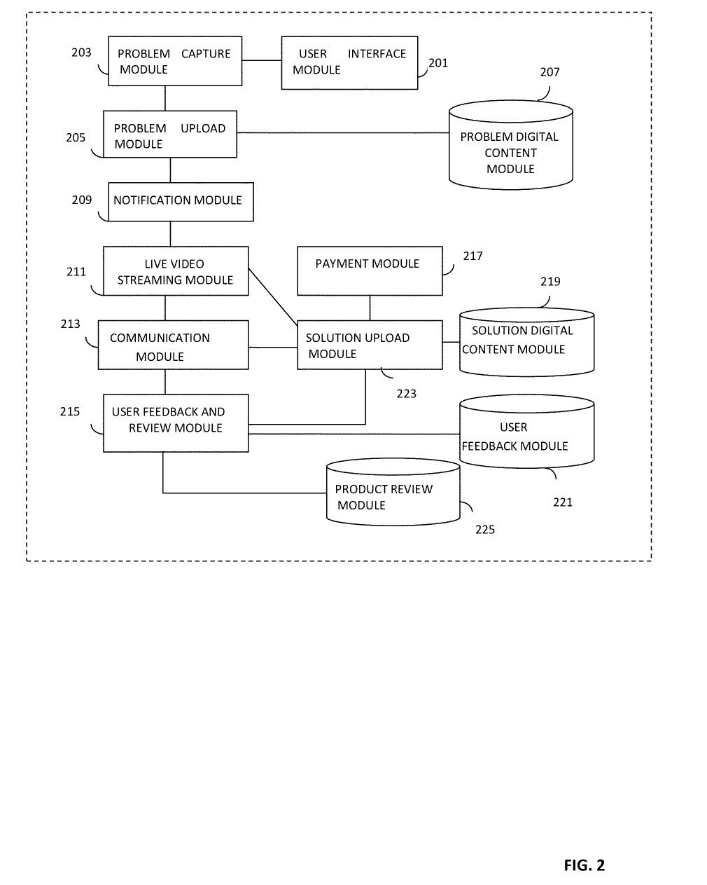

FIG. 2 depicts various operating modules representing different functionality of the present invention. These would comprise of a set of software programs and may be present on one or more remotely connected servers on the internet. The problem, solution, user feedback and product review are stored in database present in a database server, so that they can be analyzed for future use. It is to be understood that several embodiments of the present invention representing a combination of different operating modules can be achieved by use of this exemplary architecture. Component 201 denotes the User Interface module which is responsible for capturing user registration functionality. The user may be a person who is facing a problem associated with a good or service or may be an expert or a consultant capable of providing a solution to the problem. Component 203 denotes the Problem Capture module, wherein the digital content associated with a problem is captured by the user. Component 205 denotes the Problem Upload module which provides the functionality for uploading the problem on the web server. Component 209 denotes the Notification module wherein a registered expert or consultant is notified regarding an uploaded problem. Component 211 denotes the Live Video Streaming module. Component 213 denotes the Communication module for interaction between the user and a consultant or expert. Component 215 denotes the User Feedback and Review module. Component 217 denotes the Payment module, while component 223 denotes the Solution Upload module. Component 219 denotes a repository or database of digital content associated with solutions in the form of Solution Digital Content module. Component 207 denotes a repository or database of digital content associated with problems in the form of Problem Digital Content module. Component 221 denotes a repository or database of digital content associated with user feedback in the form of User Feedback module. Component 225 denotes a repository or database of digital content associated with user feedback in the form of Product Review module.

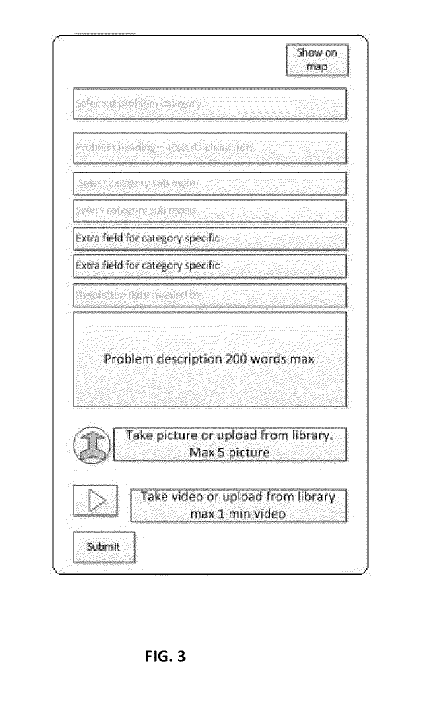

FIG. 3 is a plan view of the messages displayed on a user's Smart Device in an exemplary embodiment.

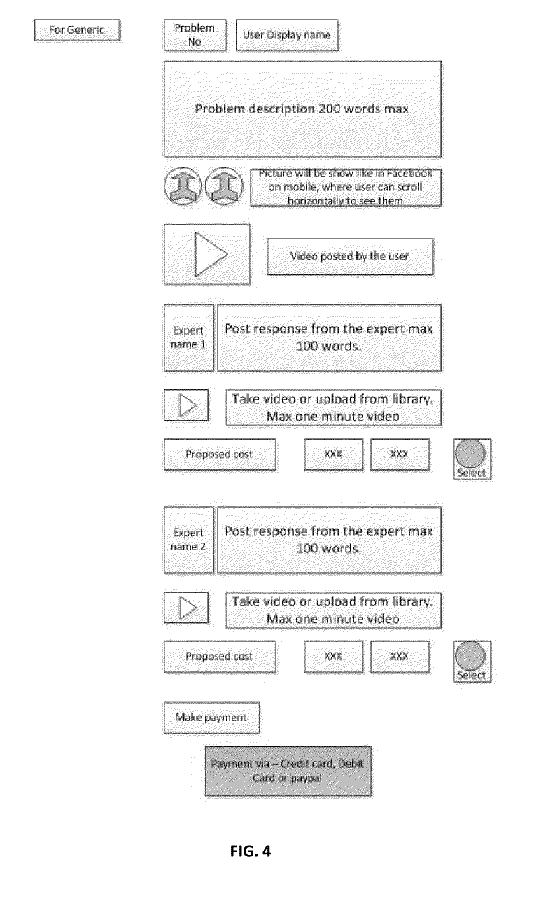

FIG. 4 is a plan view of the messages displayed on an expert's Smart Device in an exemplary embodiment.

In another embodiment of the present invention, the system in accordance with present invention includes a processor and data storage medium. The data storage medium stores the steps of the processes outlined in FIG. 1 and the processor executes these steps.

In another preferred embodiment of the present invention, the system also provides a facility of communication in real time such as live chat option, or telephonic discussion, to help the company employee or expert understand the problem posted by the user as well as to help the user understand the solution provided by the company employee or expert.

In another preferred embodiment of the present invention, the system also allows the subscription of the users. It may be envisioned that only subscribed users are permitted to post the digital content.

In another embodiment of the present invention, different subscription plans may be offered, such that an unsubscribed user can post a problem with digital content with a limited pre-specified file size or fixed duration, such as say, limited to 30 sec.

A subscribed user may be allowed to post a problem with digital content with higher file size or for a longer duration, say limited to 1 min.

In other options, the file size and duration may be decided according to the classification of the good, such as, for example, whether the good is electronic, vehicular, kitchen appliance, office equipment, or infrastructure related. These limitations may be imposed while uploading a problem.

In another embodiment, the present invention discloses a server for facilitating diagnosis of a problem associated with a user equipment remote therefrom; the server comprising a processor and at least one memory, wherein the processor and the at least one memory are arranged to cause the server to at least:
(a) receive an identifier associated with the user equipment;
(b) receive data identifying the problem associated with the user equipment, said data being in a multimedia format;
(c) retrieve one or more records corresponding to the user equipment on the basis of the received identifier from a database accessible by the server, each of the records being indicative of a technician associated with the user equipment;
(d) associate the identifier and the received data with one of the retrieved records based on a predetermined criterion;
(e) maintain the association in the database;
(f) transmit data indicative of the identifier and the received data for receipt by the technician corresponding to the associated record thereafter;
(g) enable access to the identifier and the data by the technician corresponding to the record;
(h) receive data indicative of a diagnosis associated with the problem associated with the user equipment from the technician;
(i) maintain the data indicative of the diagnosis in the database; and transmit the data indicative of the diagnosis for receipt by a user corresponding to the user equipment.

The foregoing discussion discloses and describes merely exemplary embodiments of the present invention. One skilled in the art will readily recognize from such discussion and from the accompanying drawings that various changes, modifications and variations can be made therein without departing from the spirit and scope of the invention.

The invention claimed is:

1. A system for user problem resolution and management from an internet enabled smart device through a website hosted on the internet comprising of:
a server having a CPU, the server capable of communicating with the smart device and receiving communication from the smart device, a module on the server capable of:
detecting a user's good having a problem;
causing the smart device to capture in digital content format the problem associated with the good, wherein the digital content format includes at least one of audio or video;
causing the smart device to upload the digital content format of the problem associated with the good to a web server;
selecting at least one service personnel or expert based on predetermined criterion for addressing the problem associated with the good;
notifying the selected service personnel and/or experts regarding the problem;
receiving responses, including solutions, from the selected service personnel and/or experts regarding the problem; and
selectively allowing the user to access the responses.

2. A system as claimed in claim 1, wherein the predetermined criterion is indicative of an association with a manufacturing or a servicing company associated with the good.

3. A system as claimed in claim 1, wherein the predetermined criterion is indicative of an expertise required for addressing the problem.

4. A system as claimed in claim 1, wherein the good is comprised within or different from the internet enabled smart device.

5. A system as claimed in claim 1, wherein the internet enabled smart device is a mobile device, a personal computer, a tablet, a laptop or an internet enabled television.

6. A system as claimed in claim 1, wherein the service personnel and/or the experts are selected from a set of service personnel and experts registered therewith.

7. A system as claimed in claim 1, wherein the module is configured to receive and maintain user feedback indicative of effectiveness of the service personnel or expert, or their response.

8. A system as claimed in claim 1, wherein the module is configured to maintain data indicative of problems identified in goods for use in marketing, product development, training and research.

9. A system as claimed in claim 1, wherein the uploaded digital content format is restricted to a predetermined duration and file size.

10. A system as claimed in claim 1, wherein the module is configured to cause the internet enabled smart device to detect a manufacturing company associated with the good.

11. A server for facilitating diagnosis of a problem associated with a user equipment remote therefrom, the server comprising a processor and at least one memory, wherein the processor and the at least one memory are arranged to cause the server to at least:
receive an identifier associated with the user equipment;
receive data identifying the problem associated with the user equipment, said data being in a multimedia format;
retrieve one or more records corresponding to the user equipment on the basis of the received identifier from a database accessible by the server, each of the records being indicative of a technician associated with the user equipment;
associate the identifier and the received data with one of the retrieved records based on a predetermined criterion;
maintain the association in the database;
transmit data indicative of the identifier and the received data for receipt by the technician corresponding to the associated record thereafter;
enable access to the identifier and the data by the technician corresponding to the record;
receive data indicative of a diagnosis associated with the problem associated with the user equipment from the technician;
maintain the data indicative of the diagnosis in the database; and transmit the data indicative of the diagnosis for receipt by a user corresponding to the user equipment.

12. A computer-implemented method comprising of the steps:
detecting a user's good having a problem;
causing the smart device to capture in digital content format the problem associated with the good, wherein the digital content format includes at least one of audio or video;
causing the smart device to upload the digital content format of the problem associated with the good to a web server;
selecting at least one service personnel or expert based on predetermined criterion for addressing the problem associated with the good;
notifying the selected service personnel and/or experts regarding the problem;
receiving responses, including solutions, from the selected service personnel and/or experts regarding the problem; and
selectively allowing the user to access the responses.
